(19) United States
(12) Patent Application Publication
(10) Pub. No.: US 2011/0070065 A1
(43) Pub. Date: Mar. 24, 2011

(54) Wind energy device with increased wind speed feature

(76) Inventor: Mike Xiaolei Lu, Arlington, TX (US)

(21) Appl. No.: 12/586,376

(22) Filed: Sep. 22, 2009

(51) Int. Cl. F03D 1/02; F03D 9/00

(52) U.S. Cl. 415/1; 415/68; 290/55

(57) ABSTRACT

Wind energy device is composed of an enlarged main shroud structure with flare feature to capture more on-coming wind energy, and with wind flow swirling vane feature to force the captured wind flow to rotate. A multiple stage coaxial counter rotating fan system with duct feature is attached to the main shroud to boost the wind flow energy captured by the main shroud to increase the air power passing through the fan system. The coaxial counter rotating fan's rotating direction is opposite to the captured wind flow rotating one forced by the wind flow swirling vanes for higher fan efficiency. A multiple blade supply windmill with shroud feature is mounted to the coaxial counter rotating fan system to capture and convert on-coming wind energy and supply the power to drive the coaxial counter rotating fan system to achieve inputting more energy into the wind flow captured by the main shroud through the fan system. A multiple blade main windmill at the coaxial counter rotating fan system's outlet place will capture and convert the boosted air power into mechanical energy to drive an electrical generator at the front of the device through a drive shaft passing through the coaxial counter rotating fan system. Multiple stage coaxial counter rotating fan system is an efficient approach to increase air flow energy passing through the system. The boosted air power through the coaxial counter rotating fan system will significantly increase the wind kinetic energy capacity that will well offset the cost for the components added, then generate low cost wind powered electricity.

### CROSS-REFERENCE TO RELATED APPLICATIONS

Not Applicable

### STATEMENT REGARDING FEDERALLY SPONSORED RESEARCH

Not Applicable

### REFERENCE TO A SEQUENCE LISTING

Not Applicable

### BACKGROUND OF THE INVENTION

Wind is an unlimited natural energy resource that can be utilized in many different applications. Conversion of the wind kinetic energy into windmill's mechanical energy to generate wind powered electricity through electrical generators is a major approach of utilization of renewable energy resources in the current market. Wind power is directly related to its speed. In order to generate low cost wind powered electricity, using a wind energy device that can increase the wind speed on the device by certain methods to increase the wind kinetic energy capacity to power electric generators is an approach to achieve this goal.

### SUMMARY OF INVENTION

The current key technology in wind energy application is to use wind turbines to capture wind kinetic energy and convert it into mechanical energy to power electrical generators to produce electricity. Due to the design and material limit for large size wind turbines, the current large capacity wind turbine approaches only can use two to four windmill blades with low efficiency and high installation cost.

Based on the nature of wind, wind kinetic energy is directly related to its speed. Wind speed increase will significantly increase the wind kinetic energy, therefore to increase the wind energy device's output capacity. A small multiple blades windmill can capture more wind kinetic energy to achieve higher efficiency.

According to the invention, the wind energy device is composed of an enlarged main shroud structure with flare feature to capture large mount of on-coming wind energy to increase the wind speed at the wind energy device's wind flow inlet place. Based on the aerodynamics, Wind Tunnel Effect will achieve when wind passes through a bluff body with a small opening that increases wind speed inside of the opening.

Another aspect of a preferred embodiment of the invention is to use a multiple stage coaxial counter rotating fan system with duct feature to attach to the wind energy device's wind flow inlet to capture and remove as much of the wind flow captured by the main shroud, and add more energy into the captured wind flow through this fan system to boost the captured wind flow energy. This coaxial counter rotating fan system is driven by external wind force supplied from an external windmill that captures and converts the on-coming wind energy.

Another aspect of a preferred embodiment of the invention is to use a multiple blade supply windmill attached to the coaxial counter rotating fan system's drive shaft to capture the on-coming wind energy and supply the power to drive the coaxial counter rotating fan system. A shroud feature will be included in the supply windmill blades to capture more on-coming wind energy to increase the supply windmill's driving capacity.

Another aspect of a preferred embodiment of the invention is to use a multiple blade main windmill at the wind energy device's wind flow outlet place to capture the boosted wind energy and convert it into mechanical energy to drive an electrical generator at the front of the wind energy device through a shaft passing through the coaxial counter rotating fan system.

Another aspect of a preferred embodiment of the invention is to use individual gearbox and fan modules to form the coaxial counter rotating fan system to achieve boosting the air power through the fan system. Each of modules will include coupling features that can couple the adjacent modules together. The coaxial counter rotating fan system can be built cost effectively by the modules. The fan types, blade numbers, stages and gearbox selections can be decided based on the capacity needed.

Another aspect of a preferred embodiment of the invention is to add wind flow swirling guide vanes onto the main shroud at the wind energy device's wind flow inlet place to rotate the captured wind flow against the adjacent coaxial counter rotating fan's rotating direction to increase the fan efficiency; and to add wind flow swirling guide vanes at the wind energy device's wind flow outlet place in front of the main windmill to generate air rotation to strike onto the main windmill blades with an angle to increase the main windmill's output capacity.

The accompanying drawing illustrates the example of components arrangement incorporating preferred embodiments of various aspects of the invention.

### BRIEF DESCRIPTION OF DRAWINGS

FIG. 1 illustrates the embodiment of the wind energy device with some explanations.

### DETAILED DESCRIPTION OF THE INVENTION

Like numbers refer to like elements in the following descriptions.

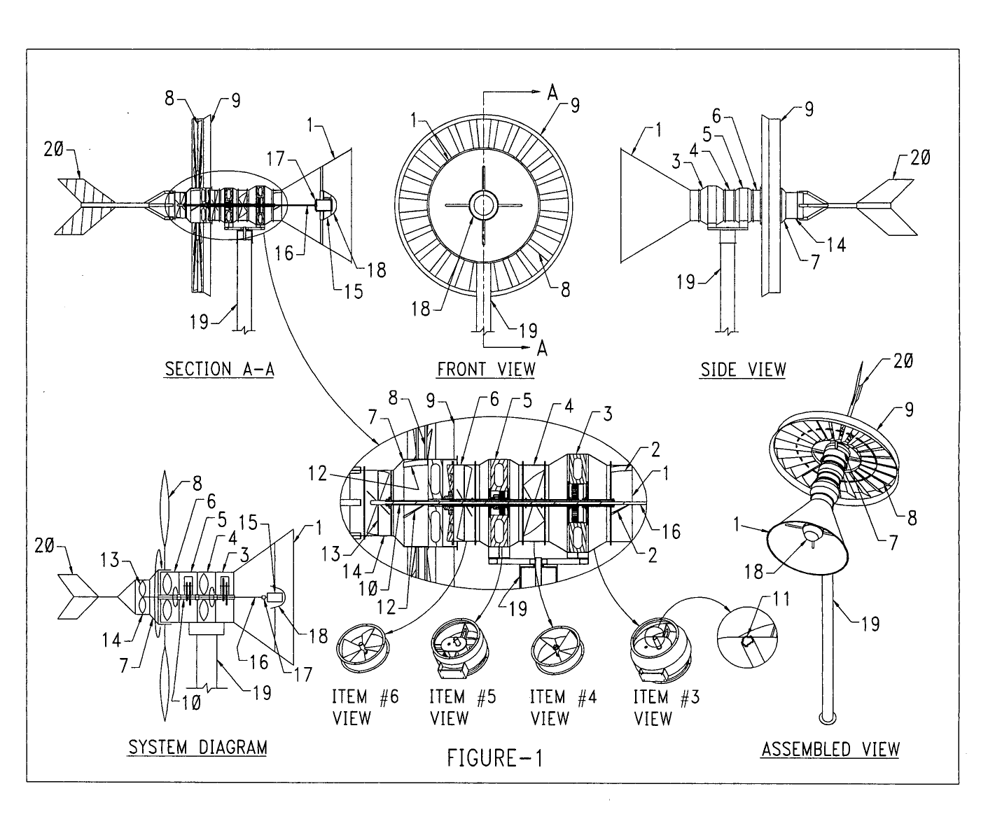

In FIG. 1, an assembled wind energy device is composed of an enlarged main shroud structure (1) to capture large mount of on-coming wind energy with wind flow swirling guide vanes (2) at the device's wind flow inlet place to force the captured wind flow to rotate. An assembled coaxial counter rotating fan system composed of four individual modules (3), (4), (5) and (6) is attached to the main shroud (1) to boost the captured wind flow air power through the fan system. The module gearbox (3) and (5) are composed of high ratio gearboxes to increase the module fan (4) and (6) rotating speeds and achieve the module fan (4) and (6) rotating in opposite directions. The module fan (4) rotating direction will be opposite to the in-coming wind flow rotating direction forced by the wind flow swirling guide vanes (2) to achieve higher efficiency. A hub structure (7) is mounted onto the coaxial counter rotating fan system for the supply windmill (8) assembly. The supply windmill (8) will include a shroud (9) to capture more on-coming wind energy. The captured wind energy by the supply windmill (8) will drive the coaxial counter rotating fan system through drive shaft (10) to boost the air power inside of the fan system. Each of the module (3), (4), (5) and (6) will include coupling features (11) that drive shaft (10) can drive all of the module components at the same time. The boosted wind flow will be forced to rotate again by the wind flow swirling guide vanes (12) at the device's wind flow outlet place to strike onto main windmill (13) with an angle to increase the main windmill (13) output capacity. The main windmill (13) completely housed inside of a shroud (14) is located at the wind energy device's wind flow outlet place to capture and convert the boosted air power to drive an electrical generator (15) at the front through a drive shaft (16) and coupling (17). An electrical generator housing structure (18) inside of the main shroud (1) will support the electrical generator (15). The whole assembled wind energy device will rotate towards the wind direction on the mounting structure (19) through the wind vane structure (20).

1. A method of using a wind energy device to generate wind powered electricity, comprising:
An enlarged main shroud structure with flare feature and wind flow swirling guide vane feature to capture large mount of on-coming wind energy to increase the wind speed at the wind energy device's inlet place and force the captured wind flow rotating;
A multiple stage coaxial counter rotating fan system that captures and removes the wind flow captured by the shroud, and input more energy into the wind flow to increase the wind flow speed, therefore to increase the wind flow kinetic energy;
A supply windmill with shroud feature mounted onto the coaxial counter rotating fan system to capture and convert the on-coming wind energy and supply the power to drive the coaxial counter rotating fan system;
A main windmill at the wind energy device's outlet place to capture and convert the boosted air power into mechanical energy to drive an electrical generator;
An electrical generator to convert the main windmill's mechanical energy into electrical energy;
A mounting structure to support the wind energy device, and rotate it towards the wind direction through a wind vane device.

2. The method of claim 1, wherein an enlarged main shroud structure with flare feature and wind flow swirling guide vane feature is used to capture more on-coming wind energy and force the captured wind flow to rotate against the adjacent coaxial counter rotating fan's rotating direction. This main shroud will include an electrical generator mounting feature at the middle to mount an electrical generator.

3. The method of claim 1, wherein a multiple stage coaxial counter rotating fan system driven by external wind force is used to boost the air power captured by the main shroud passing through the fan system. The fan types, blade numbers, speed ratios, stages and gearbox types and configurations are dependent upon the system design requirements.

4. The method of claim 3, wherein individual gearbox and fan modules are used to form the coaxial counter rotating fan system. Each module will have coupling interface features at the input and output places to couple the adjacent modules together that one drive shaft can drive all of the assembled modules at the same time.

5. The method of claim 1, wherein a multiple blade supply windmill with shroud feature is used to capture and convert on-coming wind energy to supply the power to drive the coaxial counter rotating fan system to input more energy into the wind flow captured by the main shroud passing through the fan system to increase the wind flow speed, therefore the wind flow kinetic energy. The windmill size and type are dependent upon the system requirements.

6. The method of claim 1, wherein a multiple blade main windmill within a shroud that has wind flow swirling vane feature is used at the coaxial counter rotating fan system's wind flow outlet place to capture and convert the boosted air power into mechanical energy to drive an electrical generator at the front of the wind energy device through a drive shaft passing through the coaxial counter rotating fan system.

7. The method of claim 1, wherein an electrical generator is used to be mounted at the front of the wind energy device inside of the main shroud structure for better cooling and easy maintenance.
